(19) United States
(12) Patent Application Publication
(10) Pub. No.: US 2016/0101400 A1
(43) Pub. Date: Apr. 14, 2016

(54) METHOD OF DISPOSING MATERIALS IN AN EMULSION INTO WELLS OF A DEVICE MEMBER

(71) Applicant: STAR ARRAY PTE LTD, Singapore (SG)

(72) Inventor: Haiqing GONG, Singapore (SG)

(73) Assignee: STAR ARRAY PTE LTD, Singapore (SG)

(21) Appl. No.: 14/894,536

(22) PCT Filed: May 31, 2013
(86) PCT No.: PCT/SG2013/000226

§ 371 Date: Nov. 30, 2015

(51) Int. Cl. B01J 19/00

(52) U.S. Cl. CPC B01J 19/0046; B01J 2219/00599; B01J 2219/0059; B01J 2219/00682; B01J 2219/00743; B01J 2219/00364; B01J 2219/00416; B01J 2219/00484

(57) ABSTRACT

A method of disposing materials in an emulsion (301) into wells (302) of a device member (304) is disclosed. The method comprises generating the emulsion having droplets of a specific mass and size from a fluid sample and a carrier fluid, the fluid sample being immiscible with the carrier fluid, the fluid sample comprising the materials and each droplet having at least one copy of the materials, wherein the specific mass and size of the droplets enable a force acting on the droplets to speed up the settling of at least a portion of the droplets into some of the wells.

### FIELD OF THE INVENTION

The present invention relates to a method of disposing materials in an emulsion into wells of a device member.

### BACKGROUND OF THE INVENTION

It is challenging to analyse/test for substances such as bacterial and cancer cells and molecules like DNA and proteins present in very small quantities in very dilute samples. Typically, such analyses are carried out in a microtitter plate comprising an array of wells, and more recently in an array of nanoliter or picoliter wells, to facilitate high throughput processing and analysis of samples. Conventional means of pipetting fluid samples into the wells are difficult and inefficient when the well size becomes small and potentially costly when a robotic system is used. One way to achieve the efficient and low cost fluid sample filling into an array of wells is to move the fluid sample to the space above the wells and then use vacuum to move the fluid sample into the wells. Such filling of the fluid sample into the wells under vacuum is efficient, fast and cost effective. However, these two methods generate excess fluid sample in the space outside/above the wells. Such excess fluid sample can be removed before starting analysis of the fluid sample in the wells. However, removal of the excess sample causes fluid sample waste. This is of a concern when the fluid samples are precious or limited in quantity for analysis.

One method to minimize the fluid sample waste due to removal of the excess fluid sample is typically to allow biological particles/materials in the excess sample above the wells sufficient time to settle. For instance, particles/materials (e.g. bacteria cells) of sizes in the micrometer range may take an hour to settle down in water at a settling rate of only 100 micrometer per hour, whereas particles/materials (e.g. virus or DNA molecules) of sizes in the nanometer range on the other hand may take days or even longer to settle. However, such a settlement process may take many hours or even days to complete, therefore resulting in process inefficiency since any intended analysis to be performed on the biological materials/particles can only be done after the biological materials/particles have settled into the wells.

Another aspect of challenges in biological and chemical analysis using the well array platform is to load a specific substance into a specific well with different wells in the well array to be loaded with different substances. This allows different substances to be analysed in a single test, or a single sample be tested for its interaction with different substances. Such deposition of different substances into different wells is conventionally achieved by manual or robotic pipetting, which are typically cost ineffective and time consuming.

It is therefore desirable to address some of the problems identified and/or to provide a choice that is useful in the art.

### SUMMARY OF THE INVENTION

According to a first aspect of the invention, there is provided a method of disposing materials in an emulsion into wells of a device member. The method comprises generating the emulsion having droplets of a specific mass and size from a fluid sample and a carrier fluid, the fluid sample being immiscible with the carrier fluid, the fluid sample comprising the materials and each droplet having at least one of the materials, wherein the specific mass and size of the droplets enable a force acting on the droplets to speed up the settling of at least a portion of the droplets into some of the wells.

Preferably, subsequent to the at least a portion of the droplets of the emulsion settling into some of the well of the device member, the method may further comprise providing at least a second emulsion comprising droplets of a second fluid sample dispersed in a carrier fluid immiscible with the second fluid sample, the droplets from the second emulsion having a specific mass and size, and wherein the specific mass and size of the droplets from the second emulsion enable a force acting on the droplets from the second emulsion to speed up the settling of at least a portion of the droplets from the second emulsion into some of the wells.

Further, the force may preferably include one of gravity, centrifugal force, electrical force, electro-kinetic force, electro-phoretic force, dielectro-phoretic force (DEP), SAW, and magnetic forces.

Also, generating the emulsion includes pipetting a pre-formed emulsion of the droplets formed from the fluid sample into the carrier fluid, or pipetting the individual droplets formed from the fluid sample into the carrier fluid to form the emulsion. Alternatively, generating the emulsion may otherwise include introducing the fluid sample and carrier fluid into the device member and agitating the fluid sample and carrier fluid collectively to form the emulsion having the droplets in the device member. Yet optionally, generating the emulsion may include using a droplet generation device to facilitate shearing of the continuous phase to cause a phase change of the fluid sample which is induced by flowing the carrier fluid into a path of the fluid sample to form the droplets. But further alternatively, generating the emulsion may preferably include agitating the mixture of the fluid sample and carrier fluid to disperse the fluid sample into the droplets in the carrier fluid in a fluid holder.

Preferably, the fluid holder may be a mixing chamber integral or removably attached to the device member. In addition, the method may further comprise agitating either of the emulsions in the device member to urge the at least a portion of the droplets to settle into the some of the wells. The method may also further comprise introducing the emulsion into the device member, or filling a space above the wells of the device member with a fluid prior to introducing the emulsion. More specifically, the method may further comprise substantially removing air bubbles within the wells via vacuuming, subsequent to filling the space with the fluid.

The fluid may comprise oil, a polymer resin, a silicone pre-polymer, or a third fluid sample. In addition, the method may further comprise filling a space above the wells of the device member with a sealing fluid to seal the wells, subsequent to introducing the emulsion. And the sealing fluid may comprise oil, a polymer resin, or a silicone pre-polymer. On the other hand, the third fluid sample may comprise at least one material selected from the group consisting of drug molecules, nucleic acid molecules, proteins, antibodies, tissues, biological nutrients, biological cells, microorganisms, encoding substances, and droplets having at least one of drug molecules, nucleic acid molecules, proteins, antibodies, tissues, biological nutrients, biological cells, microorganisms, and encoding substances.

The droplets may be of a substantially uniform size, or of dissimilar sizes. Further, each of the some of the wells may preferably contain only a single droplet, or each of the some of the wells may contain at least two droplets. The method may also further comprise adding a surfactant to the fluid sample and/or the carrier fluid, prior to generating the emulsion, for delaying merging of the generated droplets prior to the at least a portion of the droplets settling into some of the wells. Yet additionally, the method may further comprise adding more carrier fluid or a fluid immiscible with the carrier fluid to dilute either of the emulsions.

The device member may preferably be a microtiter plate or a cross-channel loading device having a plurality of first channels arranged transverse to a plurality of second channels, the pluralities of first and second channels being in fluid communication. Preferably, the at least a portion of the droplets may comprise substantially most of the droplets in either of the emulsions.

The method may further comprise pre-loading the wells with a biological material, which includes nucleic acid molecules or cells, wherein the material in each droplet is a specific PCR primer set or reagent to facilitate nucleic acid and cell analysis. Moreover, generating the emulsion may further include controlling generation of the droplets to have a size substantially equally to the size of an opening of each well. More preferably, the material in each droplet may be different from the material in another droplet. Further, the size of each well may be configured to enable a predetermined number of the droplets to settle into. Also, the method may further comprise pre-loading the wells with a biological or chemical material to enable interaction with the different materials held in the droplets.

It is also appreciated that mixing the fluid sample with the carrier fluid to generate the droplets may further include adding encoding materials to the respective droplets. Particularly, the encoding materials may include fluorescent dyes and particles, encodable and decodable molecules, droplets having encoding and decoding information.

Preferably, a number of the droplets generated may be less than, equal to, or greater than a number of the wells. Also preferably, wherein the number of droplets generated is less than the number of wells may include the number of droplets being substantially less than the number of wells and each droplet includes one of the material or no material. Optionally, a portion of the droplets generated each may have a size substantially smaller than the size of the well. Further, the materials in the fluid sample may preferably be of a type being biological or chemical. Preferably, the method may further comprise evenly distributing the droplets within the emulsion by using a homogenisation means.

According to a second aspect of the invention, there is provided a method of disposing materials in an emulsion into wells of a device member. The method comprises providing the emulsion of materials in a carrier fluid in the device member, wherein a force acting on the materials causes the materials to subsequently settle into some of the wells.

The materials may comprise cells, micro-organisms or tissue. And the carrier fluid may comprise an aqueous fluid.

In summary, the invention provides a way of increasing the effective mass of a materials/particle/substance (i.e. by increasing weight of, e.g., a molecule to that of a droplet) in order to speed up settlement of the substance into the wells under influence of a body force. An application, for example, includes encapsulating DNA molecules or cells in the fluid sample within aqueous droplets suspended in the carrier fluid, such as oil, to speed up the settlement of the DNA molecules or cells into the wells for analysis. Another application, for example, is to control concentrations of the droplets in the carrier fluid and the concentration of the DNA molecules or cells in the fluid sample, such that the number of droplets is significantly less than the number of the wells and the number of DNA molecules or cells is significantly less than the number of droplets. In this case, open settlement of the droplets into the wells, each well contains one or no copy of DNA molecule/cell. Additionally, the invention also provides another way of Increasing the effective size of a substance (i.e. by increasing size of, e.g., a molecule to that of a droplet) to match the size of a well so that each well allow only one or a fixed number of droplets to enter. One application is that if each droplet contains one specific type of substances and different substances are contained in different droplets, different wells may be loaded with different biological substances, when each well only allows one droplet to enter. Specifically in this case, if each droplet contains only one copy of cells or DNA molecule or nothing, each well can then be loaded with one copy of cell or DNA molecule or nothing. If the wells are preloaded with materials such as DNA molecules or cells, settlement of the respective droplets into the wells can cause interaction of the substance inside the droplets with the pre-loaded materials in the wells. Yet another application is that the sample fluid volume to be loaded into each well may precisely be metered, since a droplet generator can generate fairly uniform-sized droplets (i.e. having a variation of 1% to 5%).

In certain applications, the volume of droplets generated is lesser than the volume of the wells available and all the droplets are smaller than the size of the wells, so that all the droplets are able to enter the wells. This advantageously allows zero loss of the fluid sample to be achieved, which is one of the object of the invention.

It would be understood that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 is a flow diagram of a method of disposing droplets held in an emulsion into wells of a microtiter plate member, according to an embodiment of the invention;

FIGS. 2a to 2b depict one method for generating droplets for use in the method of FIG. 1;

FIG. 2c depicts a plan view of the wells, of the microtiter plate member of FIG. 1, with the droplets settled into the wells;

FIGS. 3a to 3d illustrate various stages of a droplet deposition step of the method of FIG. 1;

FIG. 4 depicts a method for disposing well-sized droplets into each respective well, according to a next embodiment;

FIGS. 5a and 5b illustrate further steps included in the method of FIG. 1, according to another embodiment;

FIGS. 6a to 6e different stages of a method of disposing droplets held in an emulsion into wells of a microtiter plate member, according to a further embodiment;

FIGS. 7a to 7e depict respective views of a cross-channel loading device adapted for disposing droplets held in an emulsion into wells of the device, according to yet another embodiment;

FIGS. 8a to 8d depict a method performed with use of the device of FIG. 7; and

FIG. 9 depicts a method for disposing droplets into each respective well, according to a further embodiment.

### DETAILED DESCRIPTION OF THE INVENTION

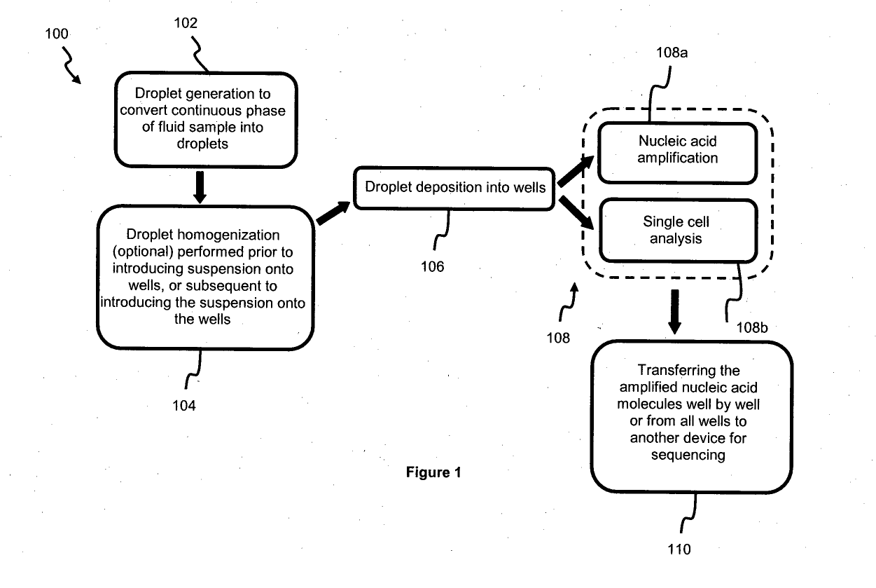

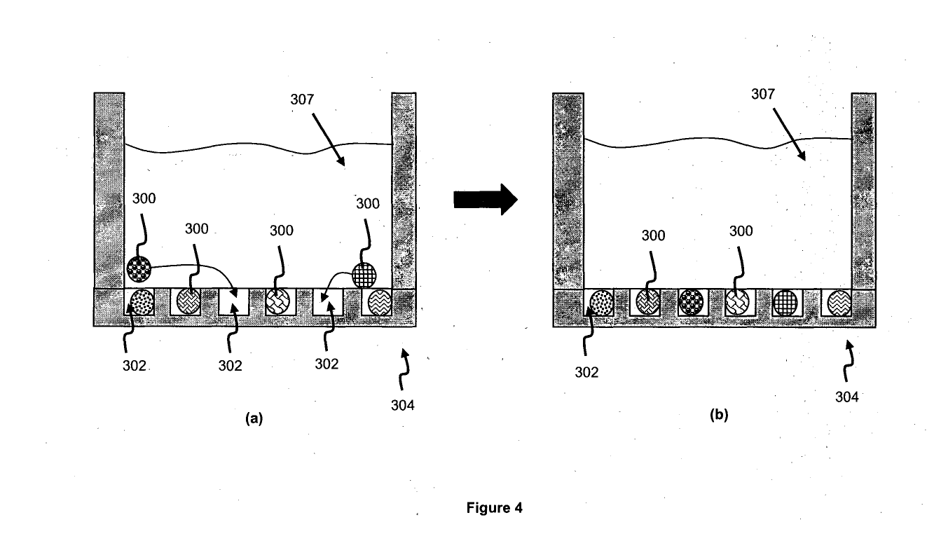

FIG. 1 depicts a flow diagram of a method 100 of disposing droplets 300 held in an emulsion 301 into a plurality of wells 302 of a microtiter plate member 304 (i.e. refer to FIG. 3), according to an embodiment of the invention. Particularly, the method 100 also includes converting the continuous phase of a fluid sample 300 into the droplets 300, which are discrete in nature. It is to be highlighted that the fluid sample 300 shares a same reference numeral as the droplets 300, since the droplets 300 are in fact generated from the fluid sample 300. In this exemplary embodiment, the microtiter plate member 304 is realised as a chip-based form factor, and is also configured with a headspace 306 arranged adjacent to the wells 302. The headspace 306 is a space arranged above the wells 302, and specifically configured to be in fluid communication with the wells 302. Indeed, as will be appreciated, FIG. 1 is a broad overview of the method 100, in which the droplets 300 are generated from the fluid sample 300 at Step 102 (also known as the “Droplet generation” step), and thereafter mixed with a carrier fluid 307 (i.e. see FIG. 3c) to obtain a droplet suspension, which is the emulsion 301. Importantly, it is to be appreciated that the fluid sample 300 comprises biological/chemical materials/particles which can be one of, for example, nucleic acid molecules like DNA, RNA, mRNA, miRNA circulating DNA, oligonucleotides, PCR primers and probes, proteins, antibody, antigens, fluorescent dye molecules, circulating tumor cells, tissues, bacterial cells, virus, protozoa, labelled and unlabelled polymer and glass beads, nanoparticles, emulsion droplets and the like. That is, the droplets 300 are suspended in the carrier fluid 307 and it is to be appreciated that the fluid sample 300 is (and of course the droplets 300 are) immiscible in the carrier fluid 307. The carrier fluid 307 can be an oil-based fluid or an aqueous fluid (e.g. water) depending on the fluid properties and characteristics of the droplets 300 generated, as well as an application intended for the method 100. Each droplet 300 is aqueous in nature and accordingly holds the same biological/chemical materials/particles that were present in the fluid sample 300. More specifically, each droplet 300, as generated, holds one of the biological/chemical materials/particles as contained in the fluid sample 300. In other words, the biological/chemical materials/particles are encapsulated by the respective droplets 300 formed from the fluid sample 300. In addition, the droplets 300 are generated to be of a specific mass and size, as desired based on needs of an application.

It will be appreciated that the biological/chemical materials/particles are pre-mixed with the fluid sample 300 before the droplets 300 are generated. However, other biological materials/particles or chemicals that do not contain biological materials/particles (e.g. analyte/target cells, or DNA, proteins) can also be encapsulated into the droplets 300 to settle into the wells 302 to interact with any biological materials/particles and chemicals that have been pre-loaded into the wells 302. It will be appreciated that a concentration of the biological/chemical materials/particles carried in each droplet 300 is controllable to, such as, desirably have a specified copy numbers of the cells or nucleic acid molecules in each droplet 300. For example, cell/DNA copy number and droplets number can be adjusted in order that the droplets number is substantially smaller (in volume) than the cell/DNA copy number. In such an instance, each droplet 300, as generated, then statistically holds no cell/DNA or only one cell/DNA. Conversely, the cell/DNA copy number and droplets number can be adjusted in order that the droplets number is substantially greater (in volume) than the cell/DNA copy number, which would then result in each droplet 300 holding a specified copy of cell/DNA.

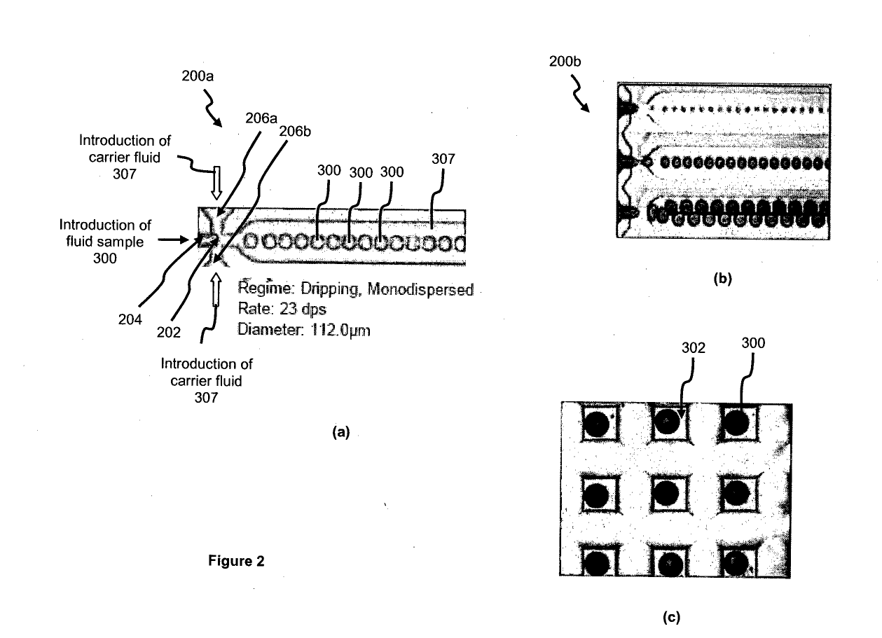

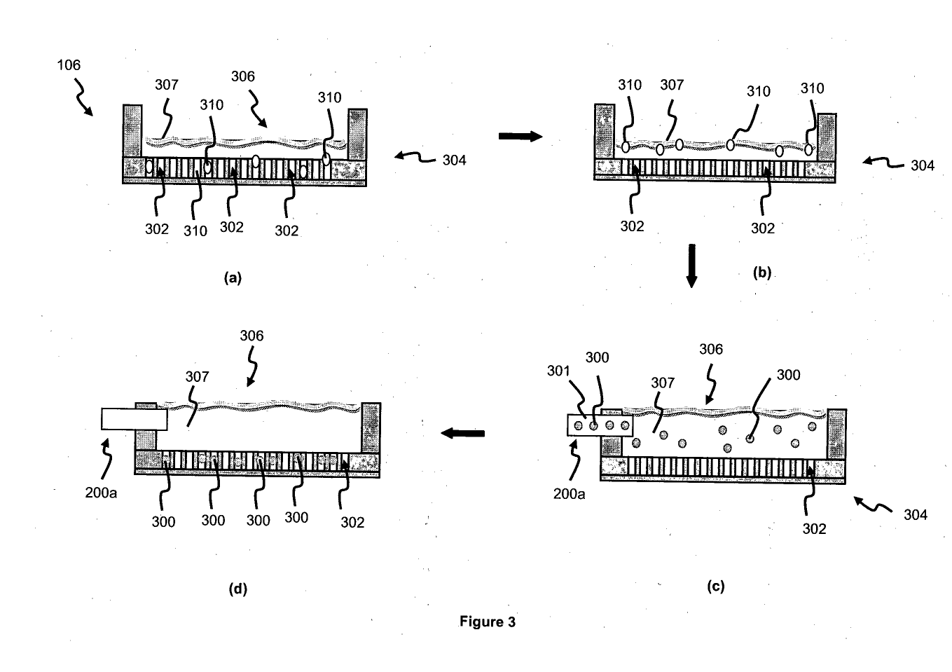

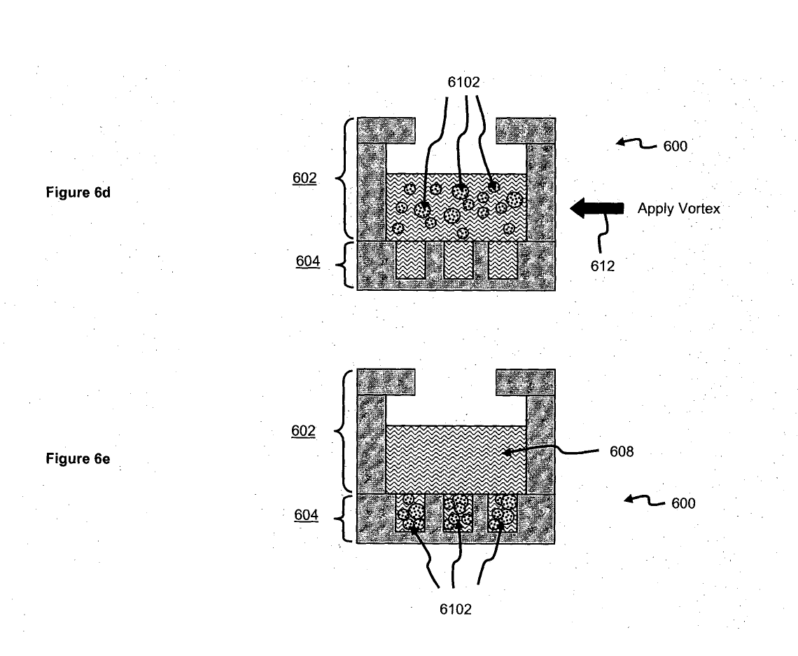

Still with regard to Step 102 of FIG. 1, number of methods can be employed, but not limited to, for generating the droplets 300 from the fluid sample 300, such as: option (a): using manual or robotic aspirating pipetting of the droplets 300 from the fluid sample 300 into the wells 302, option (b): vortexing the fluid sample 300 in a fluid holder (e.g. a test tube) to form the droplets 300 (which will be of dissimilar sizes), or option (c): generating (microfluidic) droplets 300 using flow shearing, to cause a phase change of the fluid sample 300 in the presence of the carrier fluid 307 in order to detach a series of fluid parcels of aqueous phase from the fluid sample 300 to form the droplets 300 (which will be of uniform sizes). Particularly, regarding option (a), the fluid sample 300 is mixed with the carrier fluid 307, and manual or robotic pipetting of the mixture of fluid sample 300 and carrier fluid 307 is then carried out to disperse the fluid sample 300 into droplets in the carrier fluid 307. More specifically, option (a) involves pipetting a pre-formed emulsion of the droplets 300 formed from the fluid sample 300 into the carrier fluid 307, or pipetting the individual droplets 300 formed from the fluid sample 300 into the carrier fluid 307 to form the emulsion 301. It is to be appreciated that options (a) and (c) relate to methods for encapsulating the biological/chemical materials/particles into the droplets 300 to form the emulsion 301 external to the microtiter plate member 304, and thereafter the emulsion 301 is loaded into the wells 302 which can be empty or pre-loaded with the carrier fluid 307 (i.e. refer to FIG. 3c). On the other hand, option (b) relates to a method in which a droplet generation device is integrated with the microtiter plate member 304, as shown in FIG. 6. In summary, each of the options (a), (b) or (c) allows the mass and size of each droplet 300 as formed/generated to be controllable according to what is required. That is, this then accordingly enables the effective mass and size of the biological/chemical materials/particles (when being encapsulated within the droplets 300) to be increased to facilitate their quick and speedy settlement into the wells 302 under the influence of body forces, examples of which will be elaborated in subsequent paragraphs below. Different methods may be used to control an amount of the droplets 300 generated from the fluid sample 300. Further, the method described in option (c) is shown in the diagrams 200a, 200b of FIGS. 2a and 2b in which a regime adopted for generation of the droplets 300 is classified as dripping and monodispersed, with a droplet drip rate of 23 dps (i.e. “drops per second”) and a diameter of each droplet being generated is approximately 112.0 Specifically, as shown in FIG. 2a, flow of the carrier fluid 307 creates a shear force on the continuous phase of the fluid sample 300 at a cross junction 202, formed by a horizontal channel 204 and two vertical channels 206a, 206b (of a droplet generator employed for this purpose), that detaches a portion of the continuous phase of the fluid sample 300 to form the droplets 300, which are of mono-sized. It is to be appreciated that given dimensions of the horizontal channel 204 and vertical channels 206a, 206b, the size of each droplet 300 can be controlled by flow rates of the fluid sample 300 and the carrier fluid 307, as illustrated in a series of photos in FIG. 2b. FIG. 2c shows a top plan view of a section of the microtiter plate member 304 in which the wells 302 are filled with the fluid sample droplets 300.

At Step 104 (which is optional), the emulsion 301 is agitated to cause the droplets 300 to be substantially distributed evenly within the emulsion 301. The agitation can be carried out using flow agitation (e.g. mixing the emulsion 301 on a rocker device or a vortex machine). This is to ensure that the droplets 300 are able to settle into the wells 302 in a uniform way when the emulsion 301 is subsequently introduced into the microtiter plate member 304 at Step 106. Step 104 is thus known as the “Droplet homogenisation” step. It will be appreciated that Step 104, if performed, can be carried out prior to introducing the emulsion 301 into the microtiter plate member 304, or subsequent to introducing the emulsion 301 into the microtiter plate member 304, but prior to the droplets 300 settling into the wells 302. Yet further, if Step 104 is already performed prior to introducing the emulsion 301 into the microtiter plate member 304, the emulsion 301, after being introduced into the microtiter plate member 304, can still be agitated (e.g. using flow agitation) in order to further ensure that the droplets 300 are more evenly distributed within the emulsion 301. This is especially so if it is observed that some droplets 300 have settled on the walls separating adjacent wells 302. Therefore, in this instance, agitating the emulsion 301 will urge and move the droplets 300 resting on those walls into the respective wells 302. On the other hand however, if the walls separating the adjacent wells 302 are formed sufficiently thin or relatively thinner than the droplets 300, which would not encourage the droplets 300 to stably rest on those walls, agitation of the emulsion 301 via Step 104 is then unnecessary.

At Step 106, the emulsion 301 (and the droplets 300 therewithin) is introduced into the microtiter plate member 304, but this step will instead be elaborated with reference to FIG. 3 in later paragraphs below. Step 106 is known as the “Droplet deposition” step. Thereafter, at Step 108, the microtiter plate member 304, with the droplets 300 already disposed within the wells 302, can then be separately handled as intended based on a desired sample analysis application such as for PCR analysis or for other nucleic acid amplifications (i.e. refer to Step 108a) or cell assays such as single cell analysis (i.e. refer to Step 108b). Step 108 is known as the “Sample analysis” step. It is also to be highlighted that the PCR analysis and single cell analysis shown in Step 108 merely serve as examples for illustration purposes, and are not to be construed as limiting the type of application possible based on the method 100. A further optional Step 110 may also be carried out such as transferring the amplified nucleic acid materials or cells from each of the wells 302 to another device such as a DNA sequencer, a PCR machine, a PCR array, or a gene expression array, or collecting the amplified nucleic acid materials or cells from all wells 302 and transferring them to another device for sequencing, performing PCR, or gene expression study.

Referring now to FIGS. 3a to 3d to elaborate the various stages of the droplet deposition step (i.e. Step 106) as afore briefly described with reference to FIG. 1, FIG. 3a shows a first stage whereby the wells 302 and the headspace 306 of the microtiter plate member 304 are filled with the carrier fluid 307, in which the carrier fluid 307 used can be oil or an aqueous fluid (if droplets are formed from cells, as for cell assays applications), as aforementioned. Specifically, the headspace 306 and the wells 302 are filled with the carrier fluid 307 under vacuum-like conditions. At a second stage shown in FIG. 3b, vacuum is applied to the microtiter plate member 304, in which the vacuum as applied above the surface of the carrier fluid 307 creates a pressure lower that the pressure in air bubbles 310 inside the carrier fluid 307, causing the air bubbles 310 to grow in size, and thus increase their buoyancy in the carrier fluid 307, which then causes the air bubbles 310 to move to the surface of the carrier fluid 307 and enter the vacuumed space above the surface of the carrier fluid 307. It will be appreciated that each well 302 can be preloaded with biological materials such as PCR primer pairs of the same type or different types, if necessary, before filling the headspace 306 with the carrier fluid 307. At a second stage as shown in FIG. 3b, any air bubbles 310 residing or trapped within the wells 302 are vacuum removed (via air suctioning).

Further, it is also to be appreciated that the vacuuming step can be applied starting at the first stage shown in FIG. 3a, when the carrier fluid 307 is loaded into the wells 302. In this case, the air bubbles 310 may have already been removed before the carrier fluid 307 enters into the wells 302. Accordingly, there may not be a need to further remove the air bubbles 310 at the second stage in FIG. 3b.

At a third stage shown in FIG. 3c, the carrier fluid 307 is then (optionally) subsequently removed from the headspace 306 and the emulsion 301 is subsequently introduced into the headspace 306 to dispose at least a portion of the droplets 300 into some of the wells 302. The emulsion 301 may subsequently undergo the “Droplet homogenisation” step as afore described in relation to Step 104 of FIG. 1, which is understood to be optional. It is also to be appreciated that the carrier fluid 307 can be pre-loaded (at the first stage) to treat the surfaces of the wells 302 and then be removed so that the surfaces of the wells 302 are more likely to be wetted by the oil phase of the emulsion 301 when being introduced to enter the wells 302. But alternatively, the carrier fluid 307 can also be preloaded into the wells 302 and the headspace 306 and be maintained until the loading of the emulsion 301. Thereafter, at a fourth stage shown in FIG. 3d, the emulsion 301 is allowed to stand undisturbed on the microtiter plate member 304, wherein consequently, each of the at least the portion of the droplets 300 is then caused by a body force acting on the microtiter plate member 304 to settle into a respective well 302. Examples of a body force include gravity, centrifugal force, electrical force, electro-kinetic force, electro-phoretic force, dielectro-phoretic force (DEP), SAW, magnetic forces and the like. It will also be appreciated that in a best-case scenario, all the droplets 300 in the emulsion 301 will settle into the respective wells 302. That is, the at least a portion of the droplets 300 comprises substantially most of the droplets in the emulsion 301. It is further to be appreciated that a sufficient period of time is to be allocated for enabling the droplets 300 to settle into the associated wells 302, which can further be optionally assisted by agitating the emulsion 301, if necessary. It will be appreciated that if the body force used is centrifugal force, the microtiter plate member 304 can be mounted onto a centrifuge (not shown) to allow a centrifuge force to act on the droplets to speed up their settlement into the wells 302.

In summary, FIGS. 3a to 3d describe a method of “eliminating fluid sample loss”, in which the collective volume of all the droplets 300 is less than the collective volume of wells 302, and in addition, all the droplets 300 are formed to be of a similar or smaller size than the size of the wells 302.

Yet further, the number of droplets 300 may be substantially smaller than that of the wells 302, and each droplet 300 contains one or no biological substance (i.e. one DNA/cell in each droplet 300 or an empty droplet 300). This is the case for applications related to, for example, digital PCR and single cell analysis, where preferably, all the droplets 300 are to be of the same or smaller size than the size of the wells 302, so that no fluid sample wastage is incurred.

Further embodiments of the invention will be described hereinafter. For the sake of brevity, description of like elements, functionalities and operations that are common between the embodiments are not repeated; reference will instead be made to similar parts of the relevant embodiment(s).

According to a second embodiment, with reference to the first stage as shown in FIG. 3a, the filling of the headspace 306 and the wells 302 with the fluid is omitted in this embodiment. Instead, introduction of the emulsion 301 directly into the headspace 306, and vacuum removal of air bubbles 310 from the wells 302 are simultaneously performed in order to enable the droplets 300 to subsequently settle into the wells 302 by the acting body force.

According to a third embodiment, with reference to the second stage as shown in FIG. 3b, vacuum removal of air bubbles 310 from within the wells 302 is instead omitted in this embodiment. Specifically, the emulsion 301 is instead directly introduced into the headspace 306 and the wells 302, and thereafter the droplets 300 will then consequently remove any air bubbles 310 from the wells 302 when settling into the corresponding wells 302 by pushing the air bubbles 310 out from the associated wells 302.

According to a fourth embodiment, which is an extension of the first embodiment, a droplet merging control step is further included. Particularly, the droplet merging control step includes adding to the fluid sample 300 and/or the carrier fluid 307 a surfactant of a predetermined concentration. In other words, the surfactant is added before or during the emulsion 301 is being formed. Examples of the surfactant and concentration being used include adding 2% of SPAN80 and 0.1% of Tween20 into the carrier fluid 307. The purpose of adding the surfactant is to ensure that the droplets 300 held within the emulsion 301 do not unintentionally merge with one another within a time period, such as commencing from droplet generation to settlement into the wells 302. Rather, it is desirable that the droplets 300 merge after settling into the wells 302 (under the influence of the body force). It will also be appreciated that the effectiveness of the droplet merging control step is further affected by temperature/rate of change in temperature of the carrier fluid 307 (i.e. the oil or aqueous fluid) and the droplets 300, as well as the time duration after the droplet generation and an amount of agitation applied to the carrier fluid 307 and the droplets 300. The carrier fluid 307 in this present context refers to the same carrier fluid 307 used to fill the headspace 306 in the first embodiment.

Yet the fourth embodiment (now with reference to FIG. 3), a step relating to disposing a specified number of the droplets 300 into each well 302, by tweaking certain parameters, is also further included. For example, the parameters to be tweaked include an amount of droplets 300 to be generated, a size of each droplet 300 generated, a number of wells 302 arranged on the microtiter plate member 304, and a dimensional size of each well 302 are appropriately adjusted in order that the amount of droplets 300 generated and capable of entering the wells 302 is substantially lesser than the number of wells 302 available. As a result, after settling, each well 302 will then statistically hold no droplet 300 or only one single droplet 300. In this case, each droplet 300 preferably contains a single copy of biological substance such as a single copy of DNA molecule or a single cell, so that digital PCR and single cell analysis can be performed, respectively. In this embodiment, preferably, all the droplets 300 are formed to be of the same or smaller size than the size of the wells, so that, no sample wastage is incurred. On the other hand, the same set of parameters including the amount of droplets 300 to be generated, the size of each droplet 300 generated, the number of wells 302, and the size of each well 302 can conversely be adjusted such that the amount of droplets 300 generated and capable of entering the wells 302 is instead substantially greater than the number of wells 302 available, which will then lead to each well 302 holding a specified number of droplets 300, after the droplets 300 have settled.

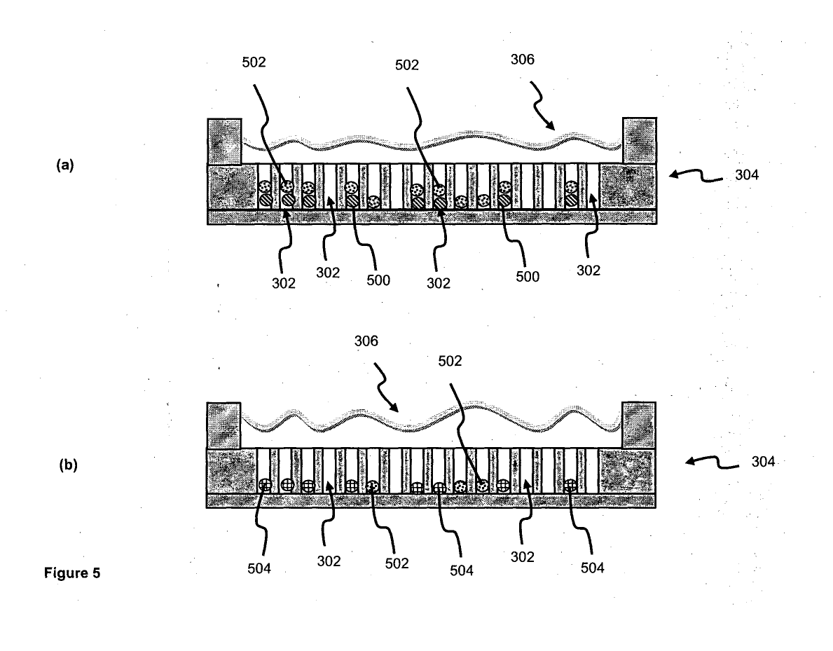

According to a fifth embodiment (as shown in FIG. 4), the size of the droplets 300 are tailored to be the same as or slightly smaller than the size of the wells 302 such that each well 302 can allow only one droplet 300 to enter. Furthermore, each droplet 300 contains one specific type of substances and different types of substances are thus contained in different droplets 300. Therefore, different wells 302 can be loaded with different biological substances. Preferably, the number of droplets 300 is the same as or slightly smaller than the number of wells 302, so that the number of the empty wells 302 is minimized. It is to be appreciated that the droplets 300, being of well-sized, are moved into the wells 302 by shaking the microtiter plate member 304 or stirring the carrier fluid 307, so that the different wells 302 can specifically be loaded with a droplet 300 containing a different substance. Moreover, each well 302 can be loaded with a same amount of the fluid sample 300.

In this fifth embodiment, the wells 302 can be pre-loaded with a biological sample such as nucleic acid molecules or cells, and each of the droplets 300 contains a specific/different PCR primer sets or reagent for nucleic acid and cell analysis, so that a high throughput analysis of the sample preloaded in the wells 302 can be obtained.

Furthermore, precise metering of the sample fluid volume to be loaded into each well can be achieved, since the droplet generator can generate very uniform-sized droplets (having a variation of 1% to 5%).

It will be appreciated that the definition of a specified number of droplets, in the context of the immediate preceding statement, includes one droplet 300 or multiple droplets 300 (i.e. at least two droplets 300).

According to a sixth embodiment, which yet extends the first embodiment by further including a new step related to filling the headspace 306 with a first sealing fluid. In particular, after the droplets 300 have settled into wells 302, the headspace 306 is filled with the first sealing fluid to seal the wells 302, and in this instance, examples of liquid that can be used as the first sealing fluid include oil, a polymer-based fluid (e.g. polymer resins), a silicone pre-polymer or the like, as an application envisaged in this embodiment relates to thermal cycling for example such as in PCR or incubation under heating. Further, the first sealing fluid can also be a curable liquid polymer (i.e. thermal curable or UV curable), which in the cured state, forms a solid sealant in the headspace 306. In addition, it will be appreciated that a liquid used as the first sealing fluid should not significantly inhibit chemical or biochemical analysis of the droplets 300, for example, using PCR. Alternatively, the sealing can also be accomplished using a solid and rigid plate, in place of the first sealing fluid, that covers the wells 302 opening to disconnect air and/or liquid communication between the wells 302/headspace 306 and the ambient.

According to a seventh embodiment, which like the sixth embodiment, also further includes a step related to filling the headspace 306 with a second sealing fluid, but is otherwise similar to the first embodiment. In particular, after the droplets 300 have settled into wells 302, the headspace 306 is filled with the second sealing fluid to seal the wells 302. In this instance, the second sealing fluid is an aqueous fluid containing nucleic acid molecules, proteins, antibodies, tissues, drug molecules or biological nutrients to facilitate biochemical interactions with the biological materials/particles contained in the droplets 300 that have settled into the wells 302.

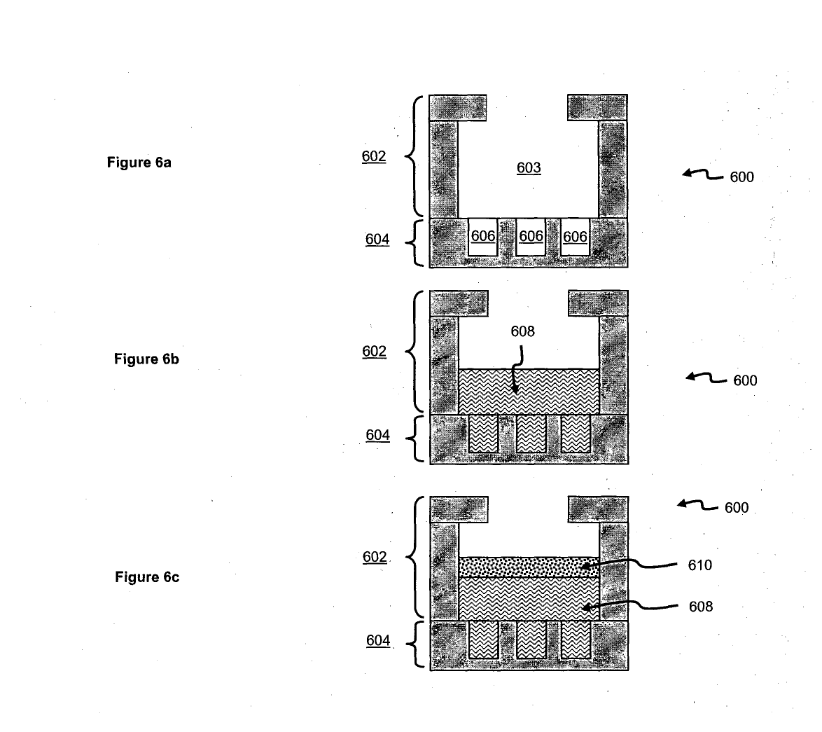

According to an eighth embodiment (with reference to FIGS. 5a and 5b), which is similar to the sixth and seventh embodiments, further includes a step related to filling the headspace 306 with a second emulsion. Particularly, after the droplets 300 have settled into wells 302, the headspace 306 is then filled with the second emulsion. In this case, the second emulsion is an aqueous fluid containing biological cells or micro-organisms to facilitate biochemical interactions with the biological materials/particles held in the droplets 300 that have settled into the wells 302. It will be appreciated that those biological cells or micro-organisms can be carried within the second emulsion in the form of droplets as well. As an example to illustrate this embodiment, FIG. 5a shows a first set of droplets 500 (which, for example, individually holds PCR primers) that have settled in some of the wells 302, and a second set of droplets 502 (which, for example, individually holds nucleic acid and PCR master mix) of the third sealing fluid are subsequently added to the headspace 306, and thereafter settling into the wells 302. It is to be highlighted that in this example, each well 302 is arranged with a space sufficiently large for holding only one droplet from the first set of droplets 500 and another droplet from the second set of droplets 502. Hence, in those wells 302 holding droplets of the first set of droplets 500 and second set of droplets 502, the respective droplets of the first set of droplets 500 and second set of droplets 502 subsequently merge to form droplets 504 (as shown in FIG. 5b), which will accordingly result in interaction between the PCR primers with the nucleic acid and PCR master mix held in the new droplets 504. An application envisaged in this example relates to performing biological assays such as PCR. Another example for this embodiment described in relation to FIG. 5 is that the first set of droplets 500 individually holds nucleic acid molecules or biological cells that have settled in some of the wells 302, and the second set of droplets 502 individually holds PCR primers or reagents to perform genetic testing or cell assays. Specifically, each of the droplets 502 in the second set contains a different PCR primer set or a different reagent from those in the other droplets 502 of the same set, and further the droplets 502 have suitable sizes that match the size of the wells 302 such that each well 302 only allows one droplet 502 to enter.

It is to be appreciated that the above multiple emulsion loading and settlement of the eighth embodiment can also be used for the fifth embodiment shown in FIG. 4, as long as the size of the droplets 300 are controlled during generation to be the same as or slightly smaller than the size of the opening of the wells 302, and the depth of the wells 302 (as configured) is sufficiently large to house at least two droplets 300.

According to a ninth embodiment (with reference to FIGS. 6a to 6e), a method of generating and disposing the emulsion 301 (together with the droplets 300) via a single integrated device 600 is described. Referring to FIG. 6a, in particular, the integrated device 600 comprises a mixer 602 (having a mixing chamber 603) integral to a microtiter plate member 604 (having a plurality of wells 606). The mixer 602 is specifically configured to generate the droplets 300 by using vortexing (which has been briefly described in the first embodiment, with reference to the Step 102 of FIG. 1, as one of the ways adoptable for generating droplets) or other suitable shaking methods. It will be appreciated that in using the integrated device 600, the wells 606 can be, if necessary, pre-loaded with biological/chemical materials/particles such as cells, PCR primers, PCR enzymes, cell lysis buffer and etc, depending on intended applications.

In detail, at a first step (as shown in FIG. 6b) of the method of this embodiment, a carrier fluid 608 (e.g. oil-based fluid or an aqueous fluid depending on an intended application) is first loaded into the mixing chamber 603 and the wells 606. Loading of the carrier fluid 608 can be accomplished by using a variety of methods such as, but not limited to, by vacuum, by centrifuge, by surface tension drive flow, by gravity and etc. At a second step (as depicted in FIG. 6c) of the method, a fluid sample 610 is next loaded into the mixing chamber 603. It will be appreciated that in this case, the fluid sample 610 is immiscible with the carrier fluid 608, and is arranged to hold biological materials/particles such as biological molecules, cells, chemicals and the like. That is, in an undisturbed state, the fluid sample 610 floats on the carrier fluid 608 upon being introduced into the mixing chamber 603. It is to be appreciated that the sequence of loading the carrier fluid 608 and the fluid sample 610 can be either vice versa. It is also further to be appreciated that the fluid sample 610 may settle at the bottom of the carrier fluid 608 if left undisturbed.

At a third step (as depicted in FIG. 6d) of the method, a vortex is applied (as indicated by a bold arrow 612 shown in FIG. 6d) to the mixing chamber 603 which now holds the carrier fluid 608 and fluid sample 610, and accordingly causes vortexing of the carrier fluid 608 and fluid sample 610 in the mixing chamber 603 such that eventually, droplets 6102 of the fluid sample 610 are generated and suspended within the carrier fluid 608. That is, the fluid sample 610 and carrier fluid 608 are agitated collectively to generate the droplets 6102. It will be appreciated that the droplets 6102 generated through vortexing are of dissimilar sizes. At a fourth step (as depicted in FIG. 6e) of the method, the droplets 6102, as generated, are then allowed to settle into the wells 606 under influence of the body forces acting on the integrated device 600. An advantage of the method of this eighth embodiment is that it does away with the step of having to transfer the droplets 6102 out of the mixing chamber 603 and then introduce those droplets 6102 into the wells of a separate microtiter plate, since in, this instance, the mixer 602 and microtiter plate member 604 are formed as a single unit. It will also be appreciated that a ratio of the fluid sample 610 to the carrier fluid 608 to be loaded into the mixing chamber 603 can be adjusted as desired, so that a number of droplets 6102 subsequently generated is controllable to be much lesser than the number of wells 606 configured in the microtiter plate member 604 to statistically enable only a single droplet 6102 to be disposed in each well 606.

Thus, in summary, the ninth embodiment comprises introducing the fluid sample 610 and carrier fluid 608 into the integrated device 600 and agitating the fluid sample 610 and carrier fluid 608 to form an emulsion, comprising the droplets 6102 in the carrier fluid 608, in the integrated device 600.

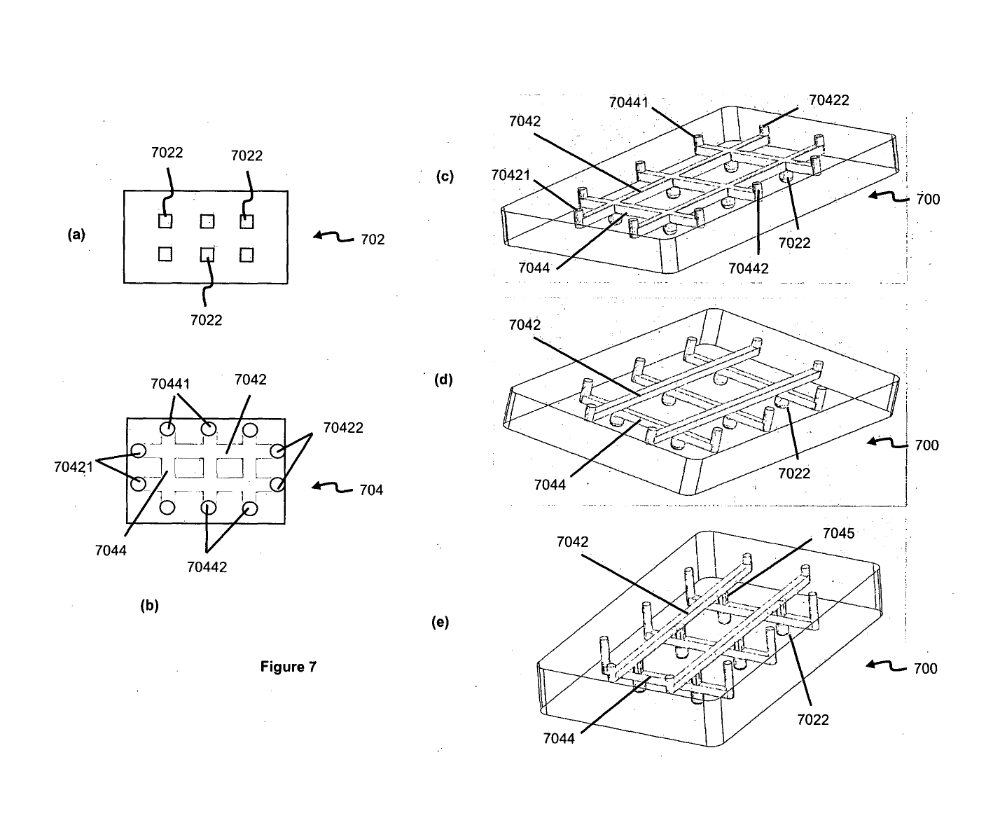

According to a tenth embodiment, FIGS. 7a and 7b show (from a top plan view perspective) respective members 702, 704 of a cross-channel loading device 700 configured for disposing droplets held in a emulsion into wells of the device 700. Specifically, FIG. 7a shows a well array layer member 702 with a set of wells 7022, while FIG. 7b shows a cross-channel layer member 704, with a plurality of x-axis channels 7042 (preferably equally spaced apart from each other) arranged across the length of the cross-channel layer member 704 with a pair of fluid inlets 70421 and fluid outlets 70422, and a plurality of y-axis channels 7044 (preferably equally spaced apart from each other) arranged across the width of the cross-channel layer member 704 with three pairs of fluid inlets 70441 and fluid outlets 70442. That is, the x-axis channels 7042 and y-axis channels 7044 are respectively substantially arranged parallel to the x-axis and y-axis of the cross-channel layer member 704. In particular, the y-axis channels 7044 are arranged to intersect the x-axis channels 7042 at respective crossing points, which approximately correspond to positions where the set of wells 7022 are located on the well array layer member 702, when the cross-channel layer member 704 is subsequently superimposed on and securely bonded to the well array layer member 702 to form the assembled device 700 with the crossing areas of the channels in fluid communication with the corresponding set of wells 7022 (refer to FIG. 7c for the perspective view of the device 700). FIG. 7d shows the x-axis channels 7042 are on top of the y-axis channels 7044 with fluid communication among the x-axis channels 7042, the y-axis channels 7044 at the crossing areas, and the corresponding set of wells 7022. FIG. 7e shows the x-axis channels 7042 are spaced apart from the y-axis channels 7044 through connection members 7045, with fluid communication among the x-axis channels 7042 and the y-axis channels 7044 at the crossing areas, and the corresponding connection members 7045, and the corresponding set of wells 7022. Separation of the x-axis channels 7042, the y-axis channels 7044 and the set of wells 7022 can minimize unintended cross flow among the channels.

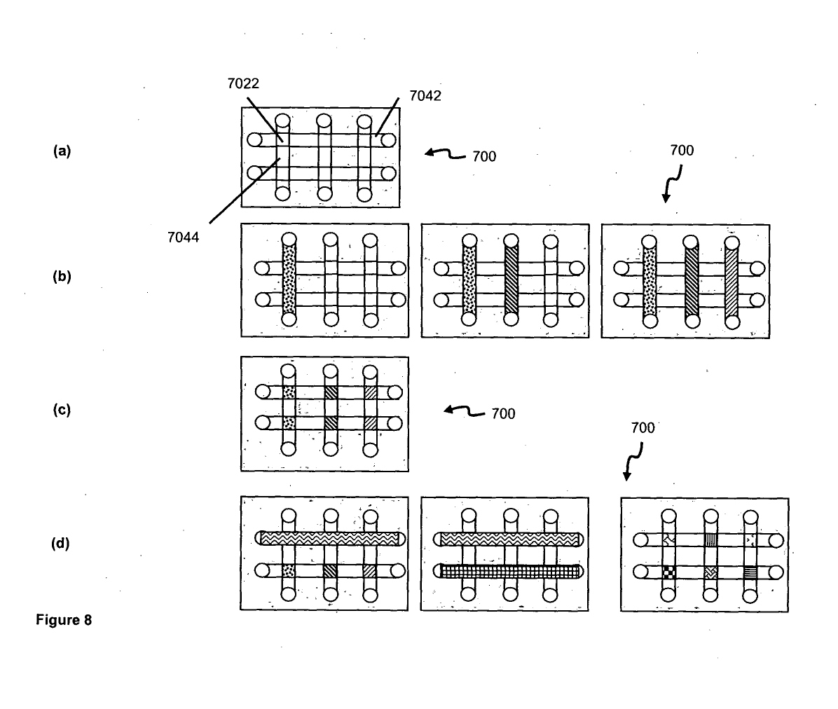

FIGS. 8a to 8d depict a corresponding method to be carried out using the device 700 of FIG. 7. In this example (without being construed as limiting in any way), the method particularly enables interaction of three different types of PCR primers and two different types of biological samples (e.g. cells or DNA/RNA), since six wells are configured as each of the set of wells 7022. It is also to be appreciated that in this instance, the x-axis channels 7042 are used for loading biological samples, whereas the y-axis channels 7044 are for loading the PCR primers.

However, it is hereby highlighted that it will also be understood that in other instances/embodiments where the device 700 is arranged with more wells as each of the set of wells 7022, the method then correspondingly enables interaction between more types of PCR primers and biological samples, and not merely limited to only three types of PCR primers and two types of biological samples (as described in the preceding paragraph). Furthermore, besides PCR primers and biological samples, other types of biochemical materials/particles, as desired, can also be utilised for the method of FIGS. 8a to 8d.

The first step as shown in FIG. 8a is an optional step. As a start, a carrier fluid (e.g. oil-based fluid or an aqueous fluid) is loaded (e.g. by using vacuum or any suitable means) into the set of wells 7022 via the x-axis and y-axis channels 7042, 7044, and the carrier fluid also fills the x-axis and y-axis channels 7042, 7044. Then, all the fluid inlets 70421 and fluid outlets 70422 are closed. It is also an optional step thereafter that, once the first and second sets of wells 7022, 7046 are completely filled with the carrier fluid, the carrier fluid residing in the x-axis and y-axis channels 7042, 7044 are then removed.

Next, in a second step shown in FIG. 8b accesses to (via the fluid inlets 70421 and fluid outlets 70422 of) all the x-axis channels 7042 are closed, while fluid access to the respective y-axis channels 7044 are opened sequentially. That is, access to each y-axis channel 7044 is opened one by one (but preferably, only one y-axis channel 7044 is open at a time) to introduce respective emulsions of droplets holding different types of PCR primers into the corresponding y-axis channel 7044, whilst accesses to the remaining y-axis channels 7044 remain closed. In this progressive manner, each y-axis channel 7044 is eventually filled with a corresponding emulsion as intended. Similar in the first embodiment, the droplets holding the different PCR primers subsequently settle into the associated set of wells 7022 under influence of the body forces (e.g. gravity, centrifugal force or electric-related forces). It is further to be appreciated that a sufficient period of time is to be allocated for enabling the droplets holding the different PCR primers to settle into the associated set of wells 7022, which can further be optically assisted using flow agitation. It is to be highlighted that it is desirable to use a carrier fluid that has more viscosity to increase the flow resistance during loading of the PCR primer droplet fluid to prevent it from cross flowing into other x-axis channels 7042.

In a third step shown in FIG. 8c, any excess of the respective emulsions of PCR primer droplets are removed from all the y-axis channels 7044. It will be appreciated that the respective emulsions now removed from the y-axis channels 7044 are substantially devoid of the droplets holding the different PCR primers since most of the droplets would have already settled into the set of wells 7022. After that, it is optional to load carrier fluid in all the y-axis channels 7044.

In a fourth step shown in FIG. 8d, accesses to (via the fluid inlets 70441 and fluid outlets 70442 of) all the y-axis channels 7044 are closed, while accesses to the two x-axis channels 7042 are opened sequentially. That is, access to each x-axis channel 7042 is opened one by one (but preferably, only one x-axis channel 7042 is open at a time) to introduce respective emulsions of droplets holding different types of biological samples into the corresponding x-axis channel 7042 (and the associated set of wells 7022), whilst access to the remaining x-axis channels 7042 remains closed. In this progressive manner, each x-axis channel 7042 is eventually filled with a corresponding emulsion as intended. Similar in the first embodiment, the droplets holding the different biological samples subsequently settle into the associated set of wells 7022 under influence of the body forces (e.g. gravity or centrifugal force). It is further to be appreciated that a sufficient period of time is to be allocated for enabling the droplets holding the different biological samples to settle into the associated set of wells 7022, which can further be optionally assisted using flow agitation. It is further to be appreciated that in FIG. 8, the x-axis channels 7042 can be loaded simultaneously, and the same applies equally to the y-axis channels 7044.

In a fifth step (which is also the optional last step of the method of FIG. 8), any excess emulsions are removed from the x-axis and y-axis channels 7042, 7044, and thereafter the x-axis and y-axis channels 7042, 7044 are then filled with a sealing fluid (e.g. oil or any suitable sealants) to seal the set of wells 7022.

It is to be understood that available methods of loading the carrier fluid or respective emulsions into the x-axis and y-axis channels 7042, 7044 include pressurization, vacuuming, electro-kinetic pumping, by centrifugation, by gravity, by acoustic forces, etc. Vibration or flow agitation can also be applied to the corresponding emulsions of droplets filled into the x-axis and y-axis channels 7042 and 7044 to move any excess droplets to regions above the associated wells 7022 to facilitate more droplets to be able to subsequently settle into those same wells 7022.

According to an eleventh embodiment (not shown), another method comprises, subsequent to the at least a portion of droplets 300 of the emulsion 301 has settled into the some of the wells 302 of the microtiter plate member 304, providing at least another emulsion (i.e. which is also an emulsion) comprising droplets of a (same/different) fluid sample dispersed in a (same/different) carrier fluid immiscible with the fluid sample in the microtiter plate member 304 and wherein a body force acting on the droplets from the at least another emulsion causes at least a portion of the droplets to subsequently settle into the some of the wells 302.

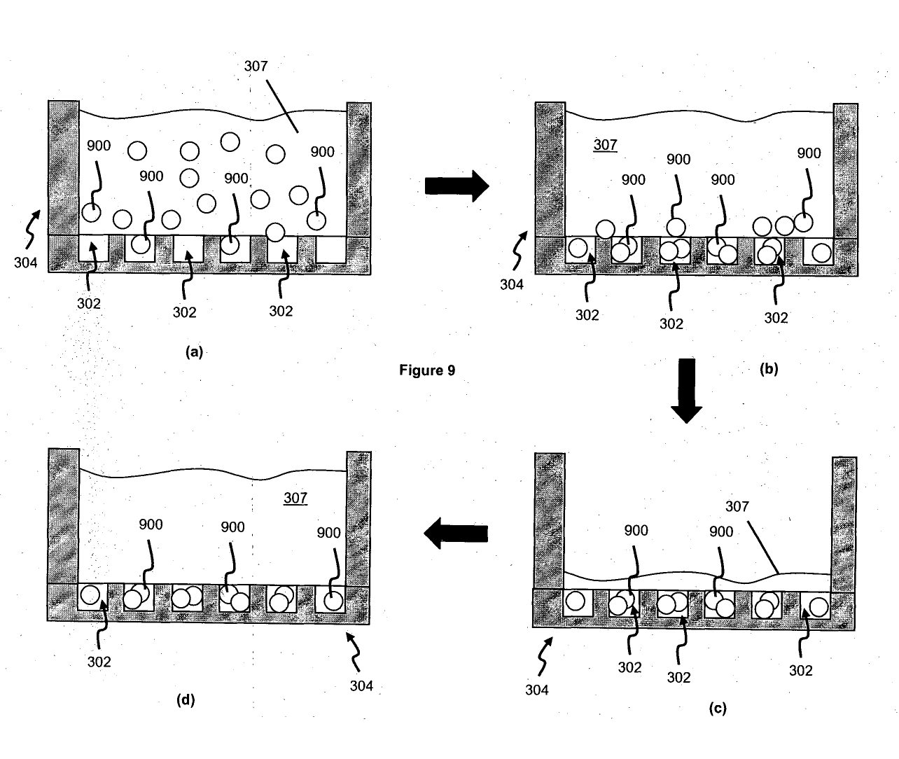

According to a twelfth embodiment as shown in FIG. 9, which is largely similar to the fifth embodiment of FIG. 4, except that in this instance the size of the droplets 300 are generated to have a wider range, some droplets 300 being smaller than the size of the wells 302, while other droplets 300 being larger than the size of the wells 302. It is also to be appreciated that a portion of the small droplets 300 may take a while to settle into the wells 302, and the large droplets 300 may not enter the wells 302. These two groups of droplets are termed excess droplets 300 hereinafter. In addition, the excess droplets 300 may be removed by draining away the carrier fluid 307 that reside outside the wells 302, after a portion of the required droplets 300 have already settled into the wells 302. Even when the generated droplets 300 are of mono-sized, those excess droplets 300 are still removable together with the carrier fluid 307 as long as a portion of the required droplets 300 enter each well 302 or a portion of the wells 302. After removing the excess droplets 300, additional carrier fluid 307 may then be added to prevent evaporation of the droplets 300 during assays such as polymerase chain reaction.

According to a thirteen embodiment, a number of the droplets 300 may substantially be less than the number of the wells 302. and each droplet 300 contains different substance from those in other droplets. This is the case for applications related to high throughput analysis, for example, multiple patient samples are each encapsulated in one droplet and settled into one well to allow simultaneous analysis in a well-plate. In addition, each droplet can be coded with fluorescent particles or molecular labels to differentiate the droplet in one well from those in other wells.

In summary, the proposed method 100 (and the various described embodiments) of disposing droplets held in an emulsion into wells of the microtiter plate member 304, the integrated device 600 or the cross-channel loading device 700 by using body forces beneficially reduce loss of cell/DNA samples incurred during the loading process to a minimum. By allowing a mass and size of each droplet as formed/generated to be controllable according to what is required accordingly then enables the effective mass and size of the biological/chemical materials/particles (when being encapsulated within the droplets 300) to be increased to facilitate their speedy settlement into the wells under the influence of the body forces. In addition, analytical parameters such as number of cells or nucleic acid copy, number of droplets, number of wells or the like can also advantageously be controllable for formulating different sample analysis methods. Furthermore, by first encapsulating the biological materials/particles in larger and heavier droplets as generated, it will correspondingly enable the biological materials/particles to quickly settle into the wells, as facilitated by the droplets as a transportation medium, within a shorter time period (as defined in seconds or minutes). By controlling the droplet size relative to the well size to allow a single droplet to enter each well, a set of different biological and chemical materials/particles/substances can be encapsulated into the corresponding set of droplets with each of these droplets entering into one well, so that a specific material/particle/substance can be loaded into a specific well, or different wells can be loaded with different materials/particles/substances. If all the wells are pre-loaded with a biological or chemical material/particle/substance, the pre-loaded material/particle/substance can interact with multiple materials/particles/substances encapsulated in the droplets, achieving a high throughput analysis.

During the formation of a droplet containing a specific biological or chemical material/particle/substance, a specific encoding material/particle/substance can be added into that particular same droplet, so that different droplets carrying different materials/particles/substances can be differentiated by the encoding materials/particles/substances. These encoding substances include fluorescent dyes and particles, molecules that can be encoded and decoded, droplets containing encoding and decoding information, etc. Envisaged applications for the proposed method 100 include genetic analysis and cell assays, in which the droplets are employed as a medium for holding biological materials/particles such as cells, proteins, chemicals and nucleic acids, and the droplets are then subsequently utilised to transport these biological materials/particles into the wells which may be empty or pre-loaded with other biological materials/particles such as cells, proteins, chemicals and nucleic acids or the like for interacting with those biological materials/particles held in the droplets.

The described embodiments should not however be construed as limitative. For example, it will be appreciated that, in the ninth embodiment, the mixer 602 may alternatively configured to be removably attachable to the microtiter plate member 604 for ease of operation, such as to enable easy cleaning of the mixer 602 and microtiter plate member 604 after (repeated) usage. Also, in relation to the tenth embodiment, the first and sixth steps may be optional for performing the corresponding method. Furthermore, at the sixth step of the method of the tenth embodiment, the x-axis and y-axis channels 7042, 7044 may alternatively be filled with oil (instead of the sealing fluid) that contains droplets holding other types of biological materials. Also, the channel 7042 and 7044 can be filled more than once, each with a different type of droplets containing a different type of material/particle/substance. It will also be appreciated that for many cell assays applications, cells to be analysed can optionally be treated and employed as droplets (provided those cells are sufficiently heavy to settle into the wells 302 by their own merits) instead of encapsulating those cells in separate droplets (such as described in the first embodiment), and a carrier fluid used may then be an aqueous fluid, instead of an oil-based fluid. In this case, an emulsion of the cells is subsequently loaded into the wells to obtain a specified number of copies of the cells in each well. Additionally, an oil-based fluid or a fluid immiscible with the carrier fluid may also be added to the emulsion that is already introduced into the microtiter plate member 304, the integrated device 600 or the cross-channel loading device 700 to dilute the emulsion. Yet further, a plurality of the at least a portion of the droplets may also be caused by the body force to subsequently settle into a respective well. Also, the emulsion may be provided by mixing the fluid sample and carrier fluid, and agitating the mixture of fluid sample and carrier sample to disperse the fluid sample into droplets in the carrier sample in a fluid holder, before introducing the emulsion into the microtiter plate member 304, the integrated device 600 or the cross-channel loading device 700.

It is also to be appreciated that in another variation, there is provided a means to generate airborne droplets and to load the droplets into a carrier fluid in the microtiter plate member 304. Specifically, the means to generate the droplets in air may be a pressure pulse generating device that is able to generate at least one pressure pulse to the continuous phase of fluid sample held in the microtiter plate member 304. The pressure pulse separates the continuous phase of the fluid sample into discrete droplets at an outlet orifice of a compartment containing the fluid sample in the pressure pulse generating device. Examples of the pressure pulse generating device include a piezo element to squeeze out the fluid sample, a solenoid valve that allows a pressure pulse of compressed air to act on the fluid sample via pressurizing, directing acoustic waves to act on the sample fluid, etc. Further, the droplets generated in the air typically fall under gravity onto the surface of a carrier fluid through an opening of a chamber that contains the carrier fluid residing above the wells. It is also to be appreciated that a plurality of airborne droplet generators can be placed over the surface of the carrier fluid, and each generator can dispense droplets containing different materials from other generators. These different materials may also be individually coded for identification purposes.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1. A method of disposing materials in an emulsion into wells of a device member, the method comprises:
generating the emulsion having droplets of a specific mass and size from a fluid sample and a carrier fluid, the fluid sample being immiscible with the carrier fluid, the fluid sample comprising the materials and each droplet having at least one of the materials,
wherein the specific mass and size of the droplets enable a force acting on the droplets to speed up the settling of at least a portion of the droplets into some of the wells.

2. The method of claim 1, further comprising:
subsequent to the at least a portion of the droplets of the emulsion settling into some of the well of the device member, providing at least a second emulsion comprising droplets of a second fluid sample dispersed in a carrier fluid immiscible with the second fluid sample, the droplets from the second emulsion having a specific mass and size, and wherein the specific mass and size of the droplets from the second emulsion enable a force acting on the droplets from the second emulsion to speed up the settling of at least a portion of the droplets from the second emulsion into some of the wells.

3. The method of claim 1, wherein the force includes one of gravity, centrifugal force, electrical force, electro-kinetic force, electro-phoretic force, dielectro-phoretic force (DEP), SAW, and magnetic forces.

4. The method of claim 1, wherein generating the emulsion includes pipetting a pre-formed emulsion of the droplets formed from the fluid sample into the carrier fluid, or pipetting the individual droplets formed from the fluid sample into the carrier fluid to form the emulsion.

5. The method of claim 1, wherein generating the emulsion includes introducing the fluid sample and carrier fluid into the device member and agitating the fluid sample and carrier fluid collectively to form the emulsion having the droplets in the device member.

6. The method of claim 1, wherein generating the emulsion includes using a droplet generation device to facilitate shearing of the continuous phase of the fluid sample which is induced by flowing the carrier fluid into a path of the fluid sample to form the droplets.

7. The method of claim 1, wherein generating the emulsion includes agitating a mixture of the fluid sample and carrier fluid to disperse the fluid sample into the droplets in the carrier fluid in a fluid holder.

8. (canceled)

9. The method of claim 1, further comprises agitating either of the emulsions in the device member to urge the at least a portion of the droplets to settle into the some of the wells.

10. The method of claim 1, further comprises introducing the emulsion into the device member.

11. The method of claim 10, further comprises filling a space above the wells of the device member with a fluid prior to introducing the emulsion.

12. The method of claim 11, further comprises substantially removing air bubbles within the wells via vacuuming, subsequent to filling the space with the fluid.

13. The method of claim 11, wherein the fluid comprises oil, a polymer resin, a silicone pre-polymer, or a third fluid sample.

14. The method of claim 10, further comprises filling a space above the wells of the device member with a sealing fluid to seal the wells, subsequent to introducing the emulsion.

15. The method of claim 14, wherein the sealing fluid comprises oil, a polymer resin, or a silicone pre-polymer.

16. The method of claim 13, wherein the third fluid sample comprises at least one material selected from the group consisting of drug molecules, nucleic acid molecules, proteins, antibodies, tissues, biological nutrients, biological cells, microorganisms, encoding substances, and droplets having at least one of drug molecules, nucleic acid molecules, proteins, antibodies, tissues, biological nutrients, biological cells, microorganisms, and encoding substances.

17-20. (canceled)

21. The method of claim 1, further comprises adding a surfactant to the fluid sample and/or the carrier fluid, prior to generating the emulsion, for delaying merging of the generated droplets prior to the at least a portion of the droplets settling into some of the wells.

22-29. (canceled)

30. The method of claim 1, wherein mixing the fluid sample with the carrier fluid to generate the droplets further includes adding encoding materials to the respective droplets.

31-36. (canceled)

37. A method of disposing materials in an emulsion into wells of a device member, the method comprising providing the emulsion of materials in a carrier fluid in the device member, wherein a force acting on the materials causes the materials to subsequently settle into some of the wells.

38. The method according to claim 37, wherein the materials comprise cells, micro-organisms or tissue.

39. The method according to claim 37, wherein the carrier fluid comprises an aqueous fluid.
